(19) United States
(12) Patent Application Publication
(10) Pub. No.: US 2020/0174492 A1
(43) Pub. Date: Jun. 4, 2020

(54) AUTONOMOUS DRIVING METHOD AND SYSTEM USING ROAD VIEW OR AERIAL VIEW MAP INFORMATION

(71) Applicant: Electronics and Telecommunications Research Institute, Daejeon (KR)

(72) Inventors: Dong Jin LEE, Daejeon (KR); Jeong Dan CHOI, Daejeon (KR); Jung Gyu KANG, Daejeon (KR); Joo Young KIM, Daejeon (KR); Kyoung Wook MIN, Sejong-si (KR); Kyung Bok SUNG, Daejeon (KR); Taeg Hyun AN, Daejeon (KR); Bong Jin OH, Daejeon (KR); Yong Woo JO, Daejeon (KR); Doo Seop CHOI, Sejong-si (KR); Seung Jun HAN, Daejeon (KR)

(73) Assignee: Electronics and Telecommunications Research Institute, Daejeon (KR)

(21) Appl. No.: 16/698,771

(22) Filed: Nov. 27, 2019

(30) Foreign Application Priority Data
Nov. 29, 2018 (KR) 10-2018-0150889

(51) Int. Cl. G05D 1/02; G01C 21/36

(52) U.S. Cl. CPC G05D 1/0278; G01C 21/367; G05D 1/0219; G01C 21/3676

(57) ABSTRACT

Provided is an autonomous driving technology in which the autonomous driving method includes planning global travelling such that guidance information of global node points is acquired, determining a location of a subject vehicle, generating a first local high-definition map such that the first local high-definition map is generated for at least one section in a global-travelling planned route included in the planning of the global travelling using at least one of a road view and an aerial view provided from a map server, planning a local route for autonomous driving using the first local high-definition map, and controlling the subject vehicle according to the planning of the local route to perform the autonomous driving.

### CROSS-REFERENCE TO RELATED APPLICATION

This application claims priority to and the benefit of Korean Patent Application No. 10-2018-0150889, filed on Nov. 29, 2018, the disclosure of which is incorporated herein by reference in its entirety.

### BACKGROUND

### 1. Field of the Invention

The present invention relates to an autonomous driving technology.

### 2. Discussion of Related Art

The following descriptions merely provide background information relevant to present embodiments rather than constituting related art.

Recently, research on autonomous driving has been actively conducted. For autonomous driving, it is required to accurately recognize external environments through sensors and determine travelling conditions, such as travelling direction and speed, on the basis of information on the recognized environments.

As the sensors for recognizing the external environments, radar and the like are used, but vision sensors are also coming into wide use to recognize more information. The vision sensors are being spotlighted due to lower price than that of other sensors.

In this regard, technology for recognizing an external environment of a vehicle using pattern recognition or image processing is remarkably developed and is expected to be greatly helpful for autonomous driving.

In order to perform autonomous driving, it is considered that a map is required at a level of a high-definition map rather than the conventional navigation map of a road network information level. Examples of information included in the high-definition map are as follows.
Road surface marking data: lane lines (dotted lines, solid lines, double lines, road boundaries, etc.), road surface marks (letters, numbers, arrows, etc.), stop lines, crosswalks, etc.
Lane centerline data: centerline data of a lane between lane lines (including intersections).
Traffic light data: signal data including height information

Using the high-definition map data, the autonomous driving technology implements the following features.
Autonomous vehicle location recognition: recognition of vehicle location/travel direction by matching data (road surface marking data) recognized using sensors with previously constructed high-definition map data
Dynamic obstacle mapping: mapping whether an obstacle (position, size, speed, type) recognized in real time is located in a travelling lane, left/right lanes, or a lane in which a risk of collision exists at a (unsignalized) signalized intersection
Static map element mapping: mapping whether stop lines, crosswalks and speed bumps exist in a travelling lane
Local route generation: generation of a local route that is followed (controlled) by an autonomous vehicle for travelling on a lane, changing lanes, passing through an intersection, etc.

Such a high-definition map is generated by collecting data using a vehicle equipped with a high-priced sensor (a mobile mapping system: MMS), and performing post-processing and requires a high cost and a great deal of time to keep up to date.

### SUMMARY OF THE INVENTION

The present invention provides an autonomous driving method and system capable of generating a high-definition map at a reduced cost and using the high-definition map for autonomous driving.

The present invention provides an autonomous driving method and system capable of performing autonomous driving even without a high-definition map being completely constructed.

The technical objectives of the present invention are not limited to the above, and other objectives may become apparent to those of ordinary skill in the art based on the following descriptions.

According to one aspect of the present invention, there is provided an autonomous driving method including planning global travelling such that guidance information of global node points is acquired, determining a location of a subject vehicle, generating a first local high-definition map such that the first local high-definition map is generated for at least one section in a global-travelling planned route included in the planning of the global travelling using at least one of a road view and an aerial view provided from a map server, planning a local route for autonomous driving using the first local high-definition map, and controlling the subject vehicle according to the planning of the local route to perform the autonomous driving.

The generating of the first local high-definition map may be performed using both of the road view and the aerial view.

The autonomous driving method may further include generating a second local high-definition map such that information about an obstacle and a marking on a road surface in a forward set distance are acquired through a sensor, and the second local high-definition map in a range corresponding to the forward set distance is generated using the acquired information, wherein the planning of the local route is performed using at least one of the first local high-definition map and the second local high-definition map.

The planning of the local route may be performed using the first local high-definition map in response to a failure for acquiring the information through the sensor.

In planning an entry route or an exit route of an intersection, the planning of the local route may be performed using the first local high-definition map in response to a failure for acquiring information about a point to which an exit road of the intersection leads due to limitation of a recognition range of the sensor.

The generating of the first local high-definition map may be performed before the generating of the second local high-definition map.

The generating of the first local high-definition map may be performed in response to a failure for performing the generating of the second local high-definition map.

The first local high-definition map may be generated for all sections of the global-travelling planned route.

The first local high-definition map may be generated before the autonomous driving starts.

According to another aspect of the present invention, there is provided an autonomous driving system including a map server configured to provide at least one of a road view and an aerial view of a road and an autonomous vehicle configured to receive the at least one of the road view and the aerial view from the map server, generate a first local high-definition map for at least one section of an autonomous driving section, establish a local route plan using the first local high-definition map, and perform autonomous driving according to the local route plan.

The autonomous vehicle may acquire information about an obstacle and a marking on a road surface in a forward set distance through a sensor, generate a second local high-definition map in a range corresponding to the forward set distance using the acquired information, and establish the local route plan using at least one of the first local high-definition map and the second local high-definition map.

The autonomous vehicle may establish the local route plan using the first local high-definition map in response to a failure for acquiring the information through the sensor.

In planning an entry/exit route of an intersection, the autonomous vehicle may establish the local route plan using the first local high-definition map in response to a failure for acquiring the information about a point to which an exit road of the intersection leads due to limitation of a recognition range of the sensor.

The first local high-definition map may be generated with respect to all sections of the autonomous driving section.

The first local high-definition map may be generated before the autonomous driving starts.

### BRIEF DESCRIPTION OF THE DRAWINGS

FIG. 1 is an example of a road view and an aerial view provided from a map server.

FIG. 2A to FIG. 2B is a flowchart showing an autonomous driving method according to an embodiment of the present invention.

FIG. 3 is a block diagram illustrating an autonomous driving system according to an embodiment of the present invention.

### DETAILED DESCRIPTION OF EXEMPLARY EMBODIMENTS

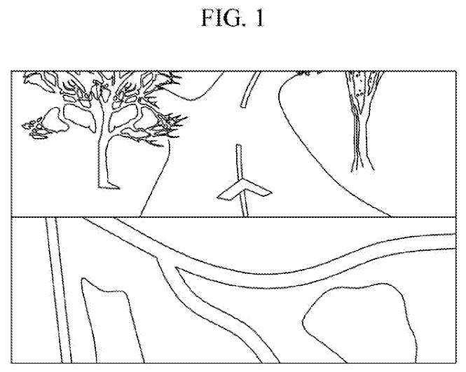

FIG. 1 is an example of a road view and an aerial view provided through a map server from Daum.

An autonomous driving method and system according to an embodiment of the present invention generates and uses a high-definition map required for autonomous driving using picture information of a road view or aerial view provided through the map server.

In particular, since the road view is provided with high precision as shown in FIG. 1, a high-definition map may be generated using the road view.

The generation of the high-definition map may be performed through well-known image processing techniques.

For example, a road view or aerial view picture is subject to image processing to acquire information about road surface marking data and traffic light data, and the information may be constructed into a map.

Here, the road surface marking data may include lane lines (dotted lines, solid lines, double lines, road boundaries, etc.), road surface marks (letters, numbers, arrows, etc.), stop lines, crosswalks, speed bumps, and the like.

In addition, the traffic light data may include height information.

The above-described information for generating a high-definition map may be obtained using both the aerial view picture and the road view picture. In the case of the aerial view, road surface markings on a road may be blocked by shadows of roadside trees or buildings so that use of the road view is desirable.

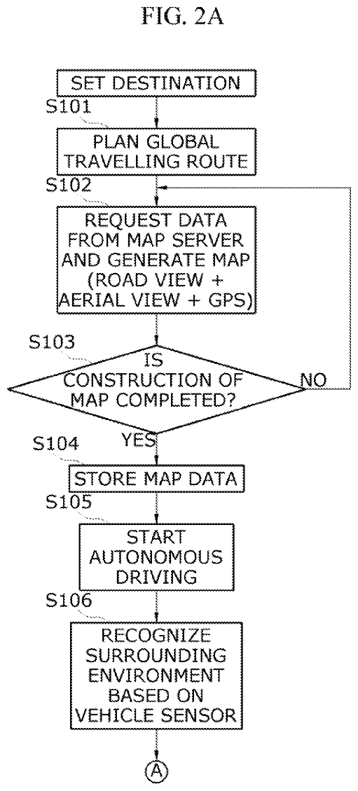

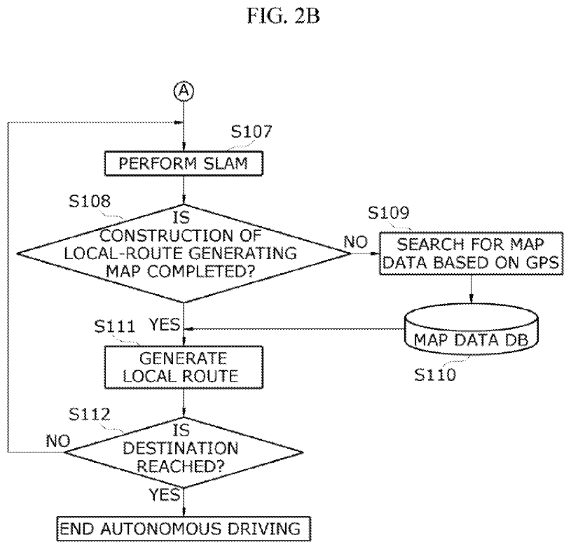

FIG. 2A to FIG. 2B is a flowchart showing an autonomous driving method according to an embodiment of the present invention.

First, when a destination is set, a global travelling plan is established (S101).

The global travelling route plan may be established in the same manner or in a similar manner as or to a route plan established by the conventional navigation device.

For the global route planning, a global route is found to generate guidance information to the destination. That is, guidance information including a route for reaching the destination and travelling direction change information at global node points, which refer to travelling direction change points in the route, is generated.

As a detailed example, the global travelling route plan may be provided as follows.
(First global route plan): Turn left at ∘∘∘ intersection and go straight for 3 km on the second lane
(Second global route plan): Turn right at xxx intersection and go straight for 10 km
. . .
Arrive at destination

A map used to generate the global route plan does not need to be a high-definition map as long as it can provide a driver with guidance information to a destination in the current navigation system. For example, a map only including road network information is sufficient for generation of the global route plan. That is, according to the embodiment of the present invention, the global route plan may be sufficiently generated without a high-definition map constructed using expensive equipment.

Alternatively, when establishing a global route plan according to an embodiment of the present invention, a high-definition map generated using a road view and aerial view picture of the map server to be described below may be used. In this case, the global route plan is not established before the high-definition map is generated, and the global route plan is established after generating the high-definition map which will be described below.

An autonomous vehicle identifies a current location, for example, through global positioning system (GPS) information.

The autonomous vehicle requests and receives road view and aerial view picture information about at least one section from the current location to the destination to and from the map server (S102). The present embodiment illustrates a case in which picture information of all sections from the current location to the destination is received.

When the global travelling route plan is established as described above, picture information of road sections corresponding to the route may be requested and received. In this regard, before the global travelling route plan is established, a map area from the current location to the destination may be divided in proper ranges and the map area divided in ranges may be received. Further, the map area may be received together with an aerial view picture, only road network information may be extracted through the aerial view picture, and then by using map information generated from the extracted road network information, the global travelling route plan may be established. Thereafter, a road view picture alone or/together with an aerial view picture) for route sections determined according to the global route plan may be requested and received.

The received aerial view and road view picture information is subject to well-known image processing so that required map information is extracted to construct a high-definition map (S103).

When the high-definition map of the route to the destination is constructed, the high-definition map is stored as data (S104), and autonomous driving is started (S105). In the present embodiment, the required high-definition map is generated before the start of autonomous driving, but the high-definition map may be generated by receiving picture information, such as a road view and the like, during travel.

The autonomous driving is performed while continuously acquiring the location of the subject vehicle and performing map matching between the location of the subject vehicle and the global route.

In this case, the autonomous driving is performed by recognizing road marking information and surrounding obstacle information within a forward set distance using a surrounding environment detection sensor (for example, radars, Lidars, vision sensors, etc.) (S106) and performing simultaneous localization and mapping (SLAM) (S107).

Here, a high-definition map is generated in real time by acquiring road marking information and fixed obstacle information through the sensor and the like, a local route plan is established by considering the high-definition map together with detected dynamic obstacles (e.g., neighboring vehicles, pedestrians, etc.) (S108), and autonomous driving is performed on a predetermined section within at least a forward set distance according to the local route plan.

In this case, when it is difficult to generate a real-time high-definition map using the sensor, for example, when the distance between an entry point and an exit point at a large intersection is great and out of the recognition range of the sensor, an exit road is not determined which causes a difficulty in generating a high-definition map for passing through the intersection. As another example, when a large obstacle exists in the middle of a roundabout while blocking an exit road and thus identifying the exit road is difficult for sensors, or when ascending on a road having sharp turns, such as a road in a mountain, it is difficult to construct a high-definition map using sensors.

As such, when it is difficult to construct a high-definition local map using sensors or the like, the data of the high-definition map generated through extraction from the picture of the road view and the like of the map server and stored in advance is read and used to establish the local route plan (S111).

According to the above-described other embodiment in which a high-definition map is not generated before the start of autonomous driving, picture information of a road view and the like may be requested to the map server at a time when it is difficult to generate a high-definition map by sensors or the like, and a high-definition local map for the corresponding section may be generated (S109 and S110).

When the destination is reached through the autonomous driving according to the global travelling route and the local route planning (S112), the autonomous driving ends.

The above-described autonomous driving method may be implemented as a program to be mounted on an autonomous vehicle and executed.

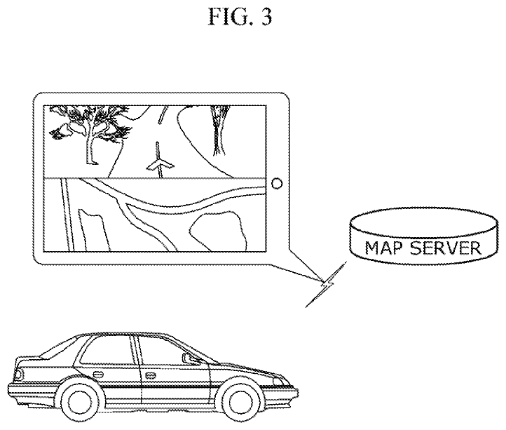

Referring to FIG. 3, an autonomous driving system according to an embodiment of the present invention includes an autonomous vehicle for performing the autonomous driving method according to the embodiment described above and a map server for providing picture information of a road view and an aerial view.

At a request of the autonomous vehicle, the map server wirelessly transmits road view and aerial view pictures of a requested section to the autonomous vehicle.

The autonomous vehicle performs the autonomous driving method as described above while communicating with the map server as such.

As is apparent from the above, the present invention can perform autonomous driving using a high-definition map generated at a relatively reduced cost without constructing a high-definition map using high priced equipment.

Although the present invention has been described with reference to the embodiments, a person of ordinary skill in the art should appreciate that various modifications, equivalents, and other embodiments are possible without departing from the scope and sprit of the present invention. Therefore, the embodiments disclosed above should be construed as being illustrative rather than limiting the present invention.

What is claimed is:

1. An autonomous driving method comprising:
planning global travelling such that guidance information of global node points is acquired;
determining a location of a subject vehicle;
generating a first local high-definition map such that the first local high-definition map is generated for at least one section in a global-travelling planned route obtained in the planning of the global travelling using at least one of a road view and an aerial view provided from a map server;
planning a local route for autonomous driving using the first local high-definition map; and
controlling the subject vehicle according to the planning of the local route to perform the autonomous driving.

2. The autonomous driving method of claim 1, wherein, in the generating of the first local high-definition map, the generating of the first local high-definition map is performed using both of the road view and the aerial view.

3. The autonomous driving method of claim 1, further comprising generating a second local high-definition map such that information about an obstacle and a marking on a road surface in a forward set distance are acquired through a sensor and the second local high-definition map in a range corresponding to the forward set distance is generated using the acquired information,
wherein the planning of the local route is performed using at least one of the first local high-definition map and the second local high-definition map.

4. The autonomous driving method of claim 3, wherein the planning of the local route is performed using the first local high-definition map in response to a failure for acquiring the information through the sensor.

5. The autonomous driving method of claim 3, wherein, in planning an entry route or an exit route of an intersection, the planning of the local route is performed using the first local high-definition map in response to a failure for acquiring information about a point to which an exit road of the intersection leads due to limitation of a recognition range of the sensor.

6. The autonomous driving method of claim 3, wherein the generating of the first local high-definition map is performed before the generating of the second local high-definition map.

7. The autonomous driving method of claim 3, wherein the generating of the first local high-definition map is performed in response to a failure for performing the generating of the second local high-definition map.

8. The autonomous driving method of claim 1, wherein, in the generating of the first local high-definition map, the first local high-definition map is generated for all sections of the global-travelling planned route.

9. The autonomous driving method of claim 1, wherein, in the generating of the first local high-definition map, the first local high-definition map is generated before the autonomous driving starts.

10. An autonomous driving system comprising:
a map server configured to provide at least one of a road view and an aerial view of a road; and
an autonomous vehicle configured to receive the at least one of the road view and the aerial view from the map server, generate a first local high-definition map for at least one section in an autonomous driving section, establish a local route plan using the first local high-definition map, and perform autonomous driving according to the local route plan.

11. The autonomous driving system of claim 10, wherein the autonomous vehicle acquires information about an obstacle and a marking on a road surface in a forward set distance through a sensor, generates a second local high-definition map in a range corresponding to the forward set distance using the acquired information, and establishes the local route plan using at least one of the first local high-definition map and the second local high-definition map.

12. The autonomous driving system of claim 11, wherein the autonomous vehicle establishes the local route plan using the first local high-definition map in response to a failure for acquiring the information through the sensor.

13. The autonomous driving system of claim 11, wherein, in planning an entry route or an exit route of an intersection, the autonomous vehicle establishes the local route plan using the first local high-definition map in response to a failure for acquiring information about a point to which an exit road of the intersection leads due to limitation of a recognition range of the sensor.

14. The autonomous driving system of claim 10, wherein the first local high-definition map is generated with respect to all sections in the autonomous driving section.

15. The autonomous driving system of claim 10, wherein the first local high-definition map is generated before the autonomous driving starts.
